(19) United States
(12) Patent Application Publication
(10) Pub. No.: US 2012/0002177 A1
(43) Pub. Date: Jan. 5, 2012

(54) PROJECTION DEVICE AND LIGHT SOURCE TEMPERATURE REGULATING METHOD THEREFOR

(76) Inventors: Chia-Jui Lin, Taoyuan Hsien (TW); Hsiu-Ming Chang, Taoyuan Hsien (TW)

(21) Appl. No.: 13/116,524

(22) Filed: May 26, 2011

(30) Foreign Application Priority Data
Jul. 2, 2010 (TW) 099121814

(51) Int. Cl. G03B 21/16; G05D 23/00

(52) U.S. Cl. 353/57; 165/287; 353/52; 353/121

(57) ABSTRACT

A projection device and a light source temperature regulating method thereof are provided. The projection device comprises a light source, a cooling unit and a control unit. The light source is operated at a working temperature. The cooling unit provides a cooling capacity to the light source. The control unit actively adjusts the cooling capacity of the cooling unit, and thus allows the working temperature of the light source to vary within the anticipated range.

This application claims the benefits of the priority based on Taiwan Patent Application No. 099121814 filed on Jul. 2, 2010, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention provides a projection device and a light source temperature regulating method thereof. In particular, the present invention provides a projection device and a light source temperature regulating method thereof to enable a working temperature of a light source to vary within a range by actively adjusting a cooling capacity of a cooling unit.

2. Descriptions of the Related Art

Projection devices have been widely applied in meetings and home theaters due to its advantage of projecting an image onto a large-size display for many users to watch. With the progress of science and manufacturing technology, the projection devices are becoming more lightweight and low profiled for good portability, high luminance and high lumen.

A conventional projection device usually adopts a single bulb or a plurality of bulbs as its light source, and light beams generated by the light source pass through various optical components to form an image which is projected onto a display screen for users to watch. Components inside the projection device may generate heat during operation. In particular, the light source usually has a maximum temperature. Therefore, a cooling unit is usually disposed to assist in heat dissipation of the light source when lit to prevent the bulb(s) per se or other components inside the projection device from being damaged due to an excessively high working temperature.

FIG. 1 illustrates a working temperature graph of the light source of the conventional projection device. The light source is lit immediately after the projection device is turned on. The temperature of the light source then rises quickly from the room temperature to the working temperature. The selected light source has a maximum tolerance temperature Tₘₐₓ and a minimum recommendation temperature Tₘᵢₙ. The optimal working temperature T_{M} of the light source usually falls within a range defined by the maximum tolerance temperature Tₘₐₓ and the minimum recommendation temperature Tₘᵢₙ. Accordingly, to remove the heat generated by the light source, the conventional projection device is usually provided with a fan which has a fixed rotating speed or a fixed voltage to guide a cooling air toward the light source or a wick thereof so that the working temperature of the light source is maintained within the range between the maximum tolerance temperature Tₘₐₓ and the minimum recommendation temperature Tₘᵢₙ as shown in FIG. 1.

However, a wick of each bulb has its respective physical properties. If the same volume of cooling airflow is provided, a state of insufficient or excessive cooling may exist for a long time period even though the working temperature of the light source may still narrowly fall within the range defined by the maximum tolerance temperature Tₘₐₓ and the minimum recommendation temperature Tₘᵢₙ. In particular, if the state of insufficient cooling exists for a long time period, the wick would stay at a relatively high temperature for a long time period, thereby resulting in recrystallization of quartz and causing the so-called whitening phenomenon; otherwise, if the state of excessive cooling exists for a long time period, the wick would stay at a relatively low temperature for a long period, thereby resulting in poor circulation of halogen and causing the so-called blackening phenomenon. Either the whitening or the blackening phenomena of the wick has an adverse affect on usability and service life of the bulb.

In view of this, an urgent need exists in the art to provide, on the basis of the existing optical system, a projection device and a light source temperature regulating method thereof that can prolong the service life of the light source.

### SUMMARY OF THE INVENTION

An objective of the present invention is to provide a projection device and a light source temperature regulating method thereof. The projection device has a cooling unit that can actively adjust a cooling capacity so that a working temperature of a light source can vary within a particular anticipated range but not stay at a fixed working temperature for a long time period. Thus, the whitening or blacking of a wick can be prevented.

Another objective of the present invention is to provide a projection device and a light source temperature regulating method thereof. In the projection device, a cooling unit for actively varying the cooling capacity can be designed to have the working temperature of a light source vary periodically or in a multi-stage way within a particular anticipated range.

To achieve the aforesaid objectives, the present invention discloses a projective device, which comprises a light source, a cooling unit and a control unit. A working temperature of the light source is defined and measured, the cooling unit is capable of cooling the light source, and the control unit can actively adjust an operation of the cooling unit. Thereby, the working temperature of the light source can vary within an anticipated range in response to the operation of the cooling unit.

The present invention further discloses a light source temperature regulating method for the aforesaid projection device, which comprises the following steps: determining a first working temperature and a second working temperature of the light source; determining a first cooling capacity and a second cooling capacity of the cooling unit in response to the first working temperature and the second working temperature; and adjusting the cooling unit actively for providing the first cooling capacity or the second cooling capacity to the light source.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a graph illustrating the variations of a light source temperature of a conventional projection device;

FIG. 2 is a schematic diagram illustrating the projection device of the present invention;

FIG. 3 to FIG. 8 are graphs illustrating the variations of a light source temperature of the projection device of the present invention; and

FIG. 9 is a flow chart of a light source temperature regulating the method of the present invention.

### DESCRIPTION OF THE PREFERRED EMBODIMENT

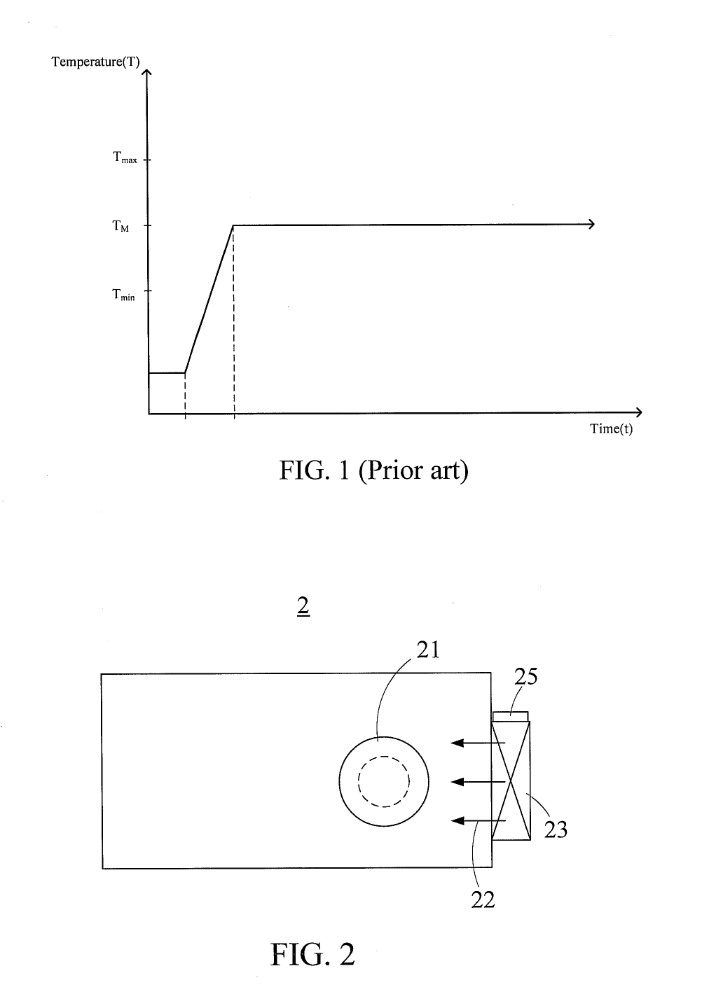

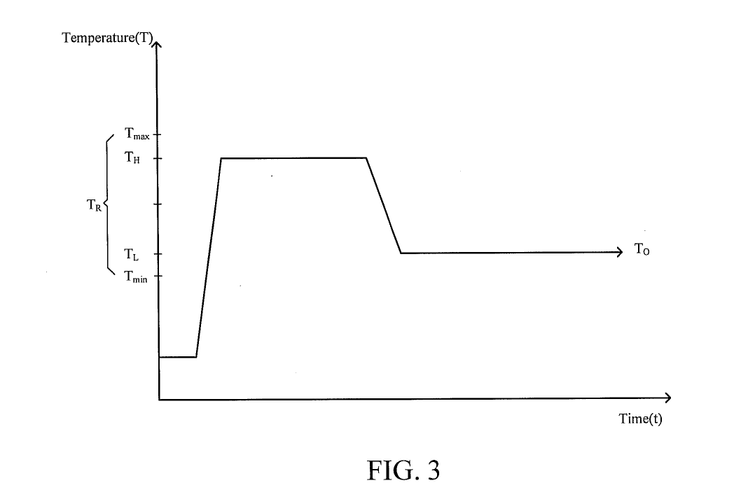

FIG. 2 and FIG. 3 illustrate a projection device of the present invention and the variations of a light source temperature of the projection device of the present invention, respectively. As shown in FIG. 2, the projection device 2 comprises a light source 21, a cooling unit 23 and a control unit 25. The light source 21 is disposed inside the projection device 2. After the light source 21 is lit, the light source 21 is operated at a working temperature T_{O} which is measurable. The cooling unit 23 is preferably disposed adjacent to the light source 21. The cooling unit 23 generates and guides a cooling airflow 22 toward the light source 21. The control unit 25 is configured to actively adjust the cooling capacity provided by the cooling unit 23 such that the working temperature T_{O} of the light source 21 varies within a tolerable anticipated range T_{R}.

Actually, the light source 21 is preferably an ultra high pressure (UHP) mercury lamp with a wick, and the wick is usually a point with a maximum temperature. The cooling unit 23 preferably comprises a fan, and the cooling airflow 22 generated by the fan blows toward the wick for cooling purposes. The control unit 25 varies a volume or a flow rate of the cooling airflow 22 by controlling the cooling unit 23 to adjust the cooling capacity. The control unit 25 can control the cooling unit 23 by actively adjusting a rotating speed or a voltage of the fan to vary the volume or the flow rate of the cooling airflow 22.

In reference to FIG. 3, the anticipated range T_{R} is defined by a maximum tolerance temperature Tₘₐₓ and a minimum recommendation temperature Tₘᵢₙ of the light source 21 together. Conceivably, the working temperature T_{O} of the light source 21 falls within the anticipated range T_{R}, i.e., the working temperature T_{O} is lower than the maximum tolerance temperature Tₘₐₓ and higher than the minimum recommendation temperature Tₘᵢₙ. The present invention is characterized in that the working temperature T_{O} can vary within the anticipated range T_{R} by using the control unit 25 to adjust the cooling capacity of the cooling unit 23.

In detail, the cooling unit 23 has a first cooling capacity and a second cooling capacity. The first cooling capacity is weaker than the second cooling capacity. The working temperature T_{O} of the light source 21 can be a first working temperature T_{H} and a second working temperature T_{L} in response to the first cooling capacity and the second cooling capacity. The first working temperature T_{H} is higher than the second working temperature T_{L}. Since the first working temperature T_{H} and the second working temperature T_{L} both fall within the anticipated range T_{R}, the first working temperature T_{H} is lower than or equal to the maximum tolerance temperature Tₘₐₓ, and the second working temperature T_{L} is higher than or equal to the minimum recommendation temperature Tₘᵢₙ.

Through the control unit 25, the first cooling capacity (e.g., the fan operated at a low rotating speed) of the cooling unit 23 can be applied to the wick to maintain the light source at the first working temperature T_{H} for a time period, and then the second cooling capacity (e.g., the fan operated at a high rotating speed) is applied to the wick so that the working temperature T_{O} of the light source falls to the second working temperature T_{L} for other time period. Because the working temperature T_{O} is changed from high to low, the wick of the bulb in the projection device 2 can be prevented from being whiten or blacken.

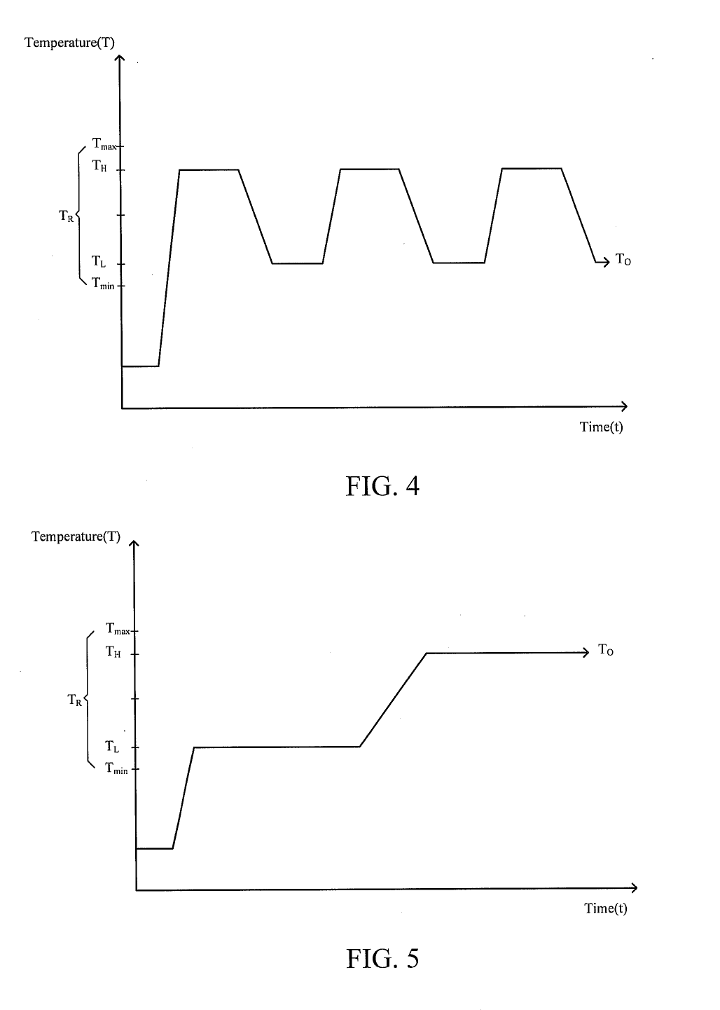

As shown in FIG. 4, the control unit 25 can further adjust the first cooling capacity and the second cooling capacity of the cooling unit 23 periodically. In other words, the control unit 25 can adjust the working temperature T_{O} to be the first working temperature T_{H} and the second working temperature T_{L} periodically. By this way, the service life of the bulb can also be prolonged effectively.

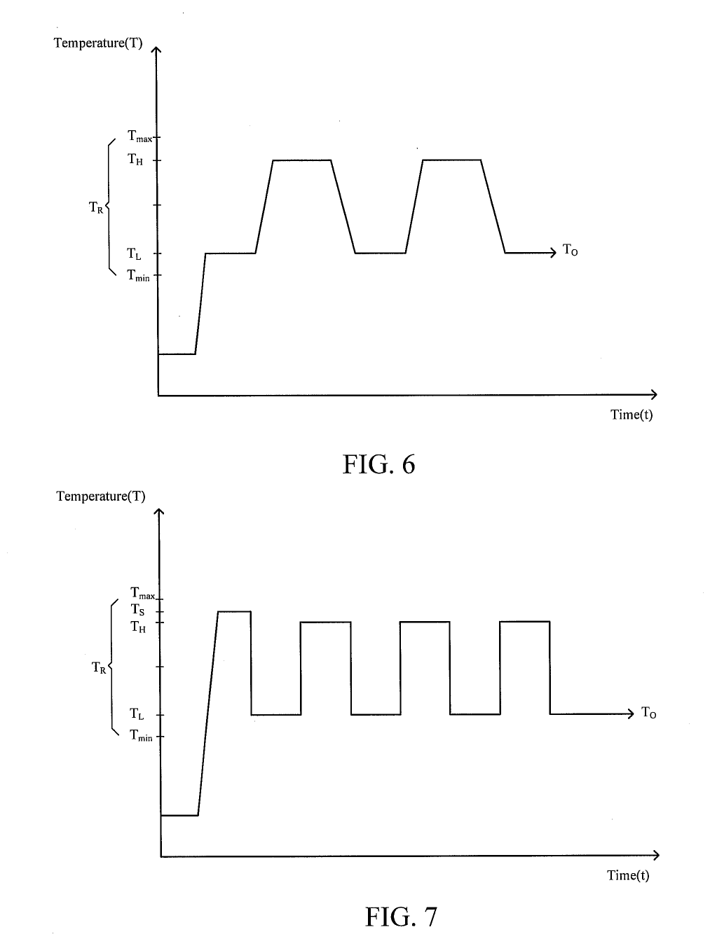

In addition to the adjusting manner as shown in FIG. 3, the control unit 25 may also first apply the second cooling capacity to the wick as shown in FIG. 5. After the working temperature T_{O} of the light source is maintained at the second working temperature T_{L} for a time period, the lower first cooling capacity is applied to the wick and then the working temperature T_{O} of the light source is gradually risen to the first working temperature T_{H} for other time period. Thus, the working temperature T_{O} is changed from low to high in a periodic cycle as shown in FIG. 6 to adjust the cooling unit 23.

In further reference to FIG. 7, the temperature of the light source 21 has a start temperature T_{S}, which is higher than the first working temperature T_{H} and lower than the maximum tolerance temperature Tₘₐₓ. When the temperature of the light source 21 reaches the start temperature T_{S}, the light source 21 is lit. At this time, the cooling unit 23 is adapted to apply the first cooling capacity or the second cooling capacity to the light source 21 to perform the aforesaid periodical adjustment on the working temperature T_{O} of the light source 21.

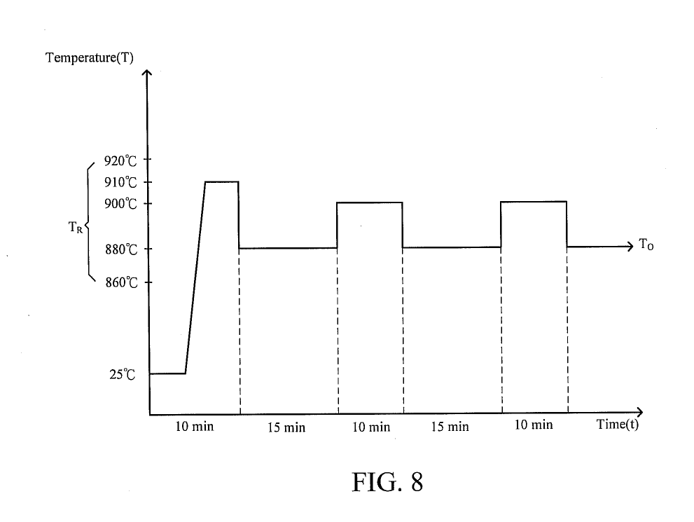

An embodiment of the present invention will be described hereinafter. In reference to FIG. 8, a working temperature T_{O} of the light source 21 in the projection device 2 is measurable, and the working temperature T_{O} can be adjusted by the control unit 25. In this embodiment, the maximum tolerance temperature Tₘₐₓ is 920° C., the minimum recommendation temperature Tₘᵢₙ is 860° C., the first working temperature T_{H} is 900° C., the second working temperature T_{L} is 880° C., and the start temperature T_{S} is 910° C. When the light source 21 is lit, the light source 21 is heated for a time period of about ten minutes to reach 910° C. from 25° C. After the working temperature T_{O} has reached at 910° C., the cooling unit 23 applies the second cooling capacity to the light source 21 so that the working temperature T_{O} falls to 880° C. Fifteen minutes later, the control unit 25 adjusts the cooling unit 23 actively to apply the first cooling capacity to the light source 21 instead so that the working temperature T_{O} then rises to 900° C. Ten minutes later, the control unit 25 re-adjusts the cooling unit 23 actively to apply the second cooling capacity to the light source 21 so that the working temperature T_{O} falls to 880° C. again. By performing this actively adjusting step repeatedly, the working temperature T_{O} varies within an anticipated range between 900° C. and 880° C. to postpone the occurrence of the whitening or blacking of the wick of the bulb.

It shall be noted that the numerical values and the time parameters of the temperatures described above are only used to illustrate the examples of the present invention but not to limit the technical features of the present invention. In addition to the first cooling capacity and the second cooling capacity described above, the present invention can further include a third cooling capacity corresponding to a third working temperature and a fourth cooling capacity corresponding to a fourth working temperature, although the present invention is not merely limited thereto. In other examples, the control unit 25 can actively adjust the cooling unit 23 to vary in different working anticipated ranges to prevent the wick of the bulb from being insufficiently cooled or excessively cooled for a long time period. Thereby, the occurrence of whitening and blackening of the wick is reduced as much as possible.

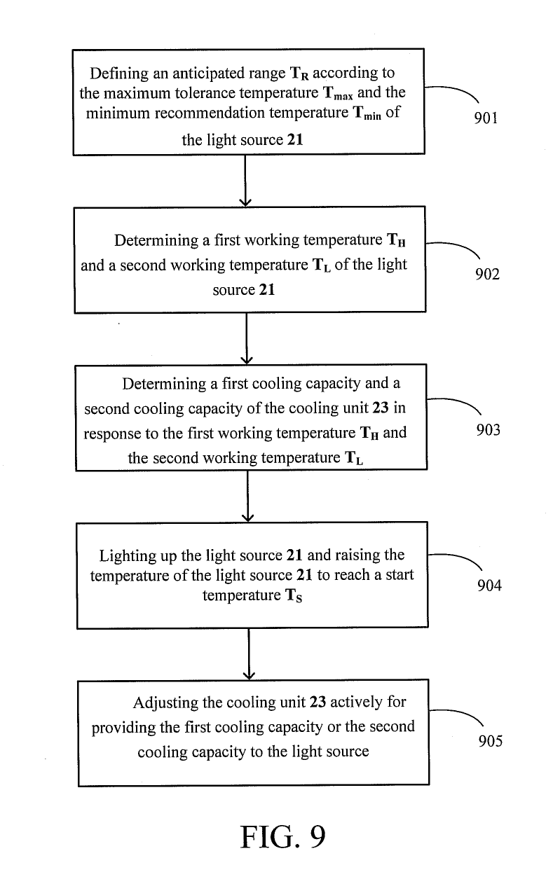

Another embodiment of the present invention is a light source temperature regulating method for use in the projection device 2, a flowchart of which is shown in FIG. 9. First, step 901 is to define an anticipated range T_{R} according to the maximum tolerance temperature Tₘₐₓ and the minimum recommendation temperature Tₘᵢₙ of the light source 21. Then, step 902 is to determine a first working temperature T_{H} and a second working temperature T_{L} of the light source 21. The first working temperature T_{H} and the second working temperature T_{L} fall within the anticipated range T_{R}, in which the first working temperature T_{H} is lower than or equal to the maximum tolerance temperature Tₘₐₓ and the second working temperature T_{L} is higher than or equal to the minimum recommendation temperature Tₘᵢₙ-Next, step 903 is to determine a first cooling capacity and a second cooling capacity of the cooling unit 23 in response to the first working temperature T_{H} and the second working temperature T_{L}. Then, step 904 is to light up the light source 21 and raise the temperature of the light source 21 to reach a start temperature T_{S}. The start temperature T_{S} is higher than the first working temperature T_{H}. Finally, step 905 is to adjust the cooling unit 23 actively for providing the first cooling capacity or the second cooling capacity to the light source 21. The first cooling capacity and the second cooling capacity of the cooling unit 23 are switched periodically.

According to above disclosures of the present invention, the cooling capacity of the cooling unit can be adjusted actively so that the working temperature of the light source can vary within a particular anticipated range but not stay fixed for a long time period. This can effectively prevent the wick from being whitened or blackened to prolong the service life of the light source.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A projection device, comprising:
a light source with a measurable working temperature;
a cooling unit for cooling the light source; and
a control unit adjusting an operation of the cooling unit;
whereby the working temperature of the light source varies within a range in response to the operation of the cooling unit.

2. The projection device as claimed in claim 1, wherein the light source is an ultra high pressure (UHP) mercury lamp having a wick.

3. The projection device as claimed in claim 2, wherein the cooling unit comprises a fan generated a cooling airflow towards the wick and the control unit adjusts the cooling unit to vary the cooling airflow.

4. The projection device as claimed in claim 3, wherein the control unit adjusts a rotating speed of the fan.

5. The projection device as claimed in claim 3, wherein the control unit adjusts a voltage of the fan.

6. The projection device as claimed in claim 3, wherein the range is defined by a maximum tolerance temperature and a minimum recommendation temperature of the light source, and the working temperature is lower than the maximum tolerance temperature and higher than the minimum recommendation temperature.

7. The projection device as claimed in claim 6, wherein the cooling unit has a first cooling capacity and a second cooling capacity in which the first cooling capacity is weaker than the second cooling capacity, and the working temperature of the light source includes a first working temperature and a second working temperature in response to the first cooling capacity and the second cooling capacity in which the first working temperature is higher than the second working temperature.

8. The projection device as claimed in claim 7, wherein the first working temperature is lower than or equal to the maximum tolerance temperature, and the second working temperature is higher than or equal to the minimum recommendation temperature.

9. The projection device as claimed in claim 8, wherein the control unit periodically adjusts the first cooling capacity and the second cooling capacity of the cooling unit.

10. The projection device as claimed in claim 9, wherein a start temperature of the light source is higher than the first working temperature, and the cooling unit starts to provide the at least one cooling capacity to the light source when the light source is lighted up and the temperature of the light source reaches the start temperature.

11. A light source temperature regulating method for a projection device, the projection device comprising a light source and a cooling device, the method comprising:
determining a first working temperature and a second working temperature of the light source;
determining a first cooling capacity and a second cooling capacity of the cooling unit in response to the first working temperature and the second working temperature; and
adjusting the cooling unit for providing the first cooling capacity or the second cooling capacity to the light source.

12. The method as claimed in claim 11, further comprising:
defining a range according to a maximum tolerance temperature and a minimum recommendation temperature of the light source, in which the first working temperature and the second working temperature are within the range.

13. The method as claimed in claim 12, wherein the first working temperature is lower than or equal to the maximum tolerance temperature, and the second working temperature is higher than or equal to the minimum recommendation temperature.

14. The method as claimed in claim 11, further comprising:
lighting up the light source to raise the temperature of the light source reaching a start temperature which is higher than the first working temperature.

15. The method as claimed in claim 11, wherein the step of adjusting the cooling unit is to switch the first cooling capacity and the second cooling capacity periodically.
